(19) United States
(12) Patent Application Publication
(10) Pub. No.: US 2025/0226606 A1
(43) Pub. Date: Jul. 10, 2025

(54) HIGH FREQUENCY SIGNAL CONNECTOR WITH IMPEDANCE CONTROL AND ATTENUATION REDUCTION FOR FLEXIBLE CIRCUIT BOARD

(71) Applicant: ADVANCED FLEXIBLE CIRCUITS CO., LTD., TAOYUAN COUNTY (TW)

(72) Inventors: GWUN-JIN LIN, TAOYUAN COUNTY (TW); KUO-FU SU, TAOYUAN COUNTY (TW); CHIH-HENG CHUO, TAOYUAN COUNTY (TW); CLINTON LIN, NEW TAIPEI CITY (TW)

(21) Appl. No.: 18/882,897

(22) Filed: Sep. 12, 2024

(30) Foreign Application Priority Data
Jan. 5, 2024 (TW) 113100618

(51) Int. Cl. H01R 12/77; H01R 12/78; H01R 12/79; H01R 13/646; H01R 13/6591

(52) U.S. Cl. CPC H01R 12/771; H01R 12/78; H01R 12/79; H01R 13/646; H01R 13/6591

(57) ABSTRACT

A high frequency signal connector with impedance control and attenuation reduction for a flexible circuit board includes a connection base and a connection circuit board. The connection circuit board is at least partly disposed in the connection base and has at least one contact end corresponding to a socket end of the connection base. The characteristic impedance and attenuation reduction characteristic of a high frequency signal transmitting through a signal transmission path of an electrically conductive layer of the connection circuit board are determined by a conductor line width, line thickness, conductive material, conductive property of the signal transmission path, and line pitch between two adjacent signal transmission paths; thicknesses and material characteristic constants of an insulation layers of the connection circuit board; distances of the signal transmission path relative to a shielding layers (or grounding layers) of the connection circuit board; and conductivity of the shielding layers.

### BACKGROUND OF THE INVENTION

### 1. Field of the Invention

The present invention relates to a connector for flexible circuit boards, and more particularly to a high frequency signal connector with impedance control and attenuation reduction for flexible circuit boards.

### 2. The Related Arts

Circuit board, flexible flat cables, flexible circuit boards, plug-in devices, and connectors are commonly used in various electronic devices or equipment to fulfill connection of circuits and transmission of electronic signals. Taking a flexible circuit board as an example, it is common practice to lay a plurality of signal transmission lines (copper foil lines), which are extended and spaced from each other by a predetermined distance, on a flexible substrate.

In the transmission of high frequency electronic signals through a signal transmission path on a flexible circuit board, if the design is poor, problems associated with poor reliability, poor impedance control, and signal attenuation may be induced during the transmission of the electronic signals. Specifically, when a high frequency electronic signal transmits through a connector a plug-in device, it is often influenced by factors of the connector or the plug-in device in relation with the structure design, the material used, and contact conductivity, so as to affect the quality and stability of signal transmission.

Further, the structure design of a conventional connector uses metallic spring plates to serve as elements for circuit connection. Although the metallic spring plates may realize the function of signal transmission, they do not have functionality in impedance control of the signal. Further, there is signal attenuation when a high frequency electronic signal is transmitted through contacts of a connector. The problems of poor impedance control and signal attenuation during transmission of a high frequency electronic signal through a connector are technical issues that must be urgently overcome in the industry.

### SUMMARY OF THE INVENTION

Thus, an objective of the present invention is to provide a high frequency signal connector with impedance control and attenuation reduction for flexible circuit boards for fulfilling an excellent effect of impedance control and attenuation reduction for transmission of high frequency signals.

To achieve the above objective, the present invention provides a high frequency signal connector with impedance control and attenuation reduction for a flexible circuit board, comprising a connection base and a connection circuit board, wherein the connection base is provided with at least one socket end and the connection circuit board is at least partly disposed in an interior space of the at least one socket end of the connection base. At least one contact end of the connection circuit board corresponds to the at least one socket end of the connection base. The connection circuit board comprises at least one electrically conductive layer, at least one insulation layer, and at least one shielding layer or grounding layer. When a high frequency signal transmits through a signal transmission path of an electrically conductive layer, the characteristic impedance and attenuation reduction characteristic thereof are determined by a conductor line width, line thickness, conductive material, conductive property of the at least one signal transmission path and line pitch between two adjacent signal transmission paths; a thickness and a material characteristic constant of the at least one insulation layer; a distance between the at least one signal transmission path and the at least one shielding layer or grounding layer and conductivity of the at least one shielding layer or grounding layer. The shielding layer is also electrically connected with the grounding conductive line to fulfill both functions of a grounding layer and electromagnetic interference resistance.

In efficacy, the connector of the present invention, when applied to connect an externally inserted flexible circuit board with a circuit component, allows a high frequency signal, during transmission, to have an excellent effect of impedance control and attenuation reduction, not suffering issues of poor impedance control and signal attenuation found in a conventional connector or plug-in device to thereby ensure quality and stability of transmission of the high frequency signal.

A technical solution adopted in the present invention will be further described with reference to embodiments provided below and the attached drawings.

### BRIEF DESCRIPTION OF THE DRAWINGS

FIG. 1 is a perspective view of a first embodiment of the present invention;

FIG. 2 is a cross-sectional view taken along line A-A of FIG. 1, showing a cross-sectional view of an embodiment of a connection circuit board according to the present invention;

FIG. 3 is an enlarged view of circled region C of FIG. 2;

FIG. 4 is a cross-sectional view taken along line B-B of FIG. 1;

FIG. 5 is a cross-sectional view showing an example of application of the present invention to a multiple-layer wiring board;

FIG. 6 is an exploded view showing the first embodiment of the present invention connecting an externally inserted flexible circuit board with a circuit component;

FIG. 7 is a cross-sectional view taken along line D-D of FIG. 6, showing, in an exploded form, the first embodiment of the present invention connecting the externally inserted flexible circuit board with the circuit component;

FIG. 8 is a cross-sectional view showing the first embodiment of the present invention connecting the externally inserted flexible circuit board with the circuit component;

FIG. 9 is a perspective view of a second embodiment of the present invention;

FIG. 10 is a cross-sectional view, showing, in an exploded form, the second embodiment of the present invention connecting an externally inserted flexible circuit board with a circuit component;

FIG. 11 is a cross-sectional view showing the second embodiment of the present invention connecting the externally inserted flexible circuit board with the circuit component;

FIG. 12 is a cross-sectional view showing a third embodiment of the present invention connecting an externally inserted flexible circuit board with a circuit component;

FIG. 13 is a cross-sectional view showing a fourth embodiment of the present invention connecting an externally inserted flexible circuit board with the circuit component; and

FIG. 14 is a cross-sectional view showing a fifth embodiment of the present invention connecting a flexible circuit board with a circuit component.

### DETAILED DESCRIPTION OF THE PREFERRED EMBODIMENTS

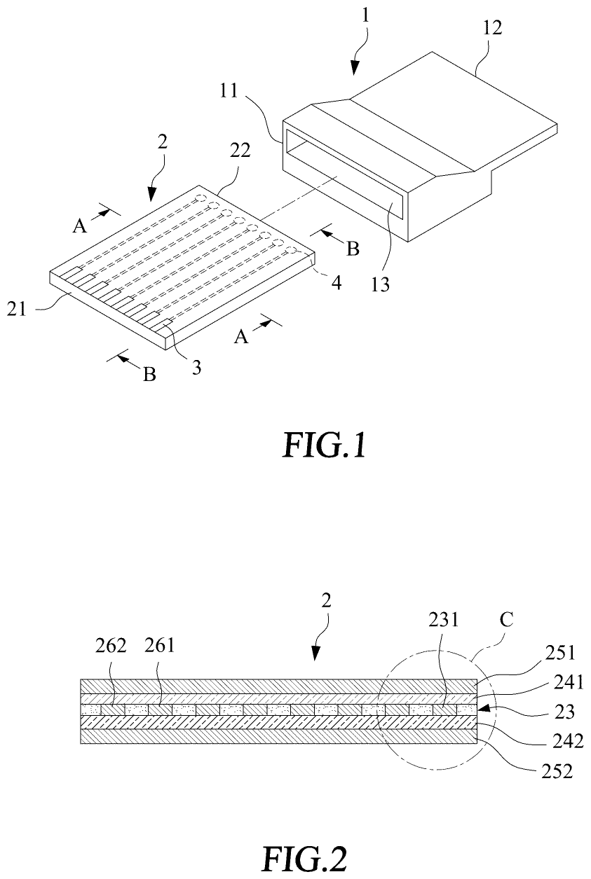

Referring simultaneously to FIGS. 1-5, a perspective view of a first embodiment of the present invention is shown. The present invention provides a high frequency signal connector with impedance control and attenuation reduction for a flexible circuit board, comprising a connection base 1 provided with a socket end 11 and a connection end 12. A channel 13 is formed in an interior space of the connection base 1, communicating between the socket end 11 and the connection end 12.

A connection circuit board 2 is arranged in the channel 13 of the connection base 1, such that the connection circuit board 2 is at least partly disposed in the interior space at the socket end 11 of the connection base 1. In the embodiment illustrated in the drawings, the connection circuit board 2 is received in the channel 13 and extends between the socket end 11 and the connection end 12, so that a contact end 21 and a conductive connection end 22 of the connection circuit board 2 are respectively set to correspond to the socket end 11 and the connection end 12.

The connection base 1 is made of a material selected from one of plastics and metals or a combination of the two, and the connection circuit board 2 and the connection base 1 can be fixed through adhering with adhesive layers, mechanical fastening, injection molding, or a combination of at least two of them.

FIG. 2 is a cross-sectional view taken along line B-B of FIG. 1, showing that the connection circuit board 2 comprises an electrically conductive layer 23, and at least one signal transmission path 231 is formed on the electrically conductive layer 23. The electrically conductive layer 23 has a top surface and a bottom surface that are each covered with an insulation layer 241, 242. A shielding layer (or grounding layer) 251 is formed on a top surface of the insulation layer 241 and a shielding layer (or grounding layer) 252 is formed on ae bottom surface of the insulation layer 242. As such, the shielding layer (or grounding layer) 251 is set to correspond to the electrically conductive layer 23 as being separated therefrom by the insulation layer 241, and the shielding layer (or grounding layer) 252 is set to correspond to the electrically conductive layer 23 as being separated therefrom by the insulation layer 242.

The insulation layer 241, 242 can be one of a substrate, a covering film, and pure resin, or a combination thereof, and comprises a material selected from one of PI, LCP, fluorine-series materials, COP, PP, glass fibers, PET, epoxy, acrylic resins, and coating materials.

The connection circuit board 2 may comprise at least one power source conductive line 261 and at least one grounding conductive line 262, and the at least one grounding conductive line 262 is electrically connected with the shielding layer (or grounding layer) 251 and/or the shielding layer (or grounding layer) 252, so that the shielding layer (or grounding layer) 251 and the shielding layer (or grounding layer) 252 possess functions of both a grounding layer and electromagnetic interference resistance. Further, in an embodiment of the present invention, the connection base 1 comprises at least a part of material that comprises metal, and the metal is electrically connection with the shielding layer (or grounding layer) 251 and/or the shielding layer (or grounding layer) 252 of the connection circuit board 2.

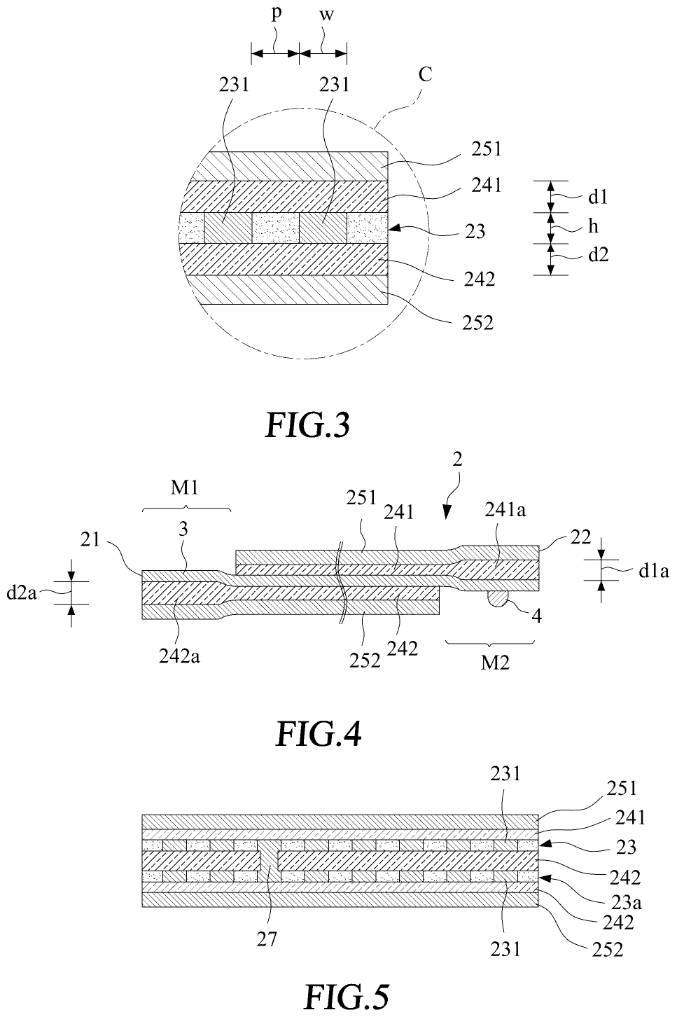

Also referring to FIG. 3, in designing the connection circuit board 2, according to the requirements for impedance control and signal attention reduction for high frequency signals, the signal transmission path 231 has preset line width w, line pitch p, and line thickness h; and the insulation layers 241, 242 have preset thicknesses d1, d2 and other material characteristic constants; the signal transmission path 231 is spaced from the shielding layers (or grounding layers) 251, 252 by preset distances. Thus, when a high frequency signal (which can be one of a differential mode signal and a common mode signal, or coexistence of both) is transmitted through the signal transmission path 231 of the connection circuit board 2, the characteristic impedance of the high frequency signal is determined according to one value or more than two values of the following:
(a) conductor line width w, line thickness h, conductive material, conductive property (for example, including metallic materials such as selected conductor, gold, silver, copper, and aluminum or metallic alloys) of the signal transmission path 231, and line pitch between two adjacent signal transmission paths 231;
(b) thicknesses d1, d2 and material characteristic constants thereof of the insulation layers 241, 242, (for example, including selected insulative material, dielectric constant, and loss factor); and
(c) distances of the signal transmission path 231 relative to the shielding layers (or grounding layers) 251, 252, and conductivity of the shielding layers or the grounding layers.

FIG. 4 is a cross-sectional view taken along line B-B of FIG. 1, showing a plurality of golden fingers 3 disposed on the contact end 21 of the connection circuit board 2, arranged in the form of a single row or a multiple row array, to electrically connect with the signal transmission path 231 of the electrically conductive layer 23 and corresponds to the socket end 11 of the connection base 1.

To control the signal attenuation reduction function of the plurality of golden fingers 3, a first attenuation reduction section M1 is provided adjacent to the contact end 21 of the connection circuit board 2. In a preferred embodiment, the thickness of the insulation layer 242 located in the first attenuation reduction section M1 is increased to form a thickened insulation layer 242a, so that the thickness d2a of the thickened insulation layer 242a located in the first attenuation reduction section M1 is made larger than the thickness d2 of the insulation layer 241 in other regions. As such, the signal attenuation reduction function of the golden fingers 3 can be controlled by means of the thickness and the material constant of the insulation layer located in the first attenuation reduction section M1.

Further, the signal attenuation reduction function of the golden fingers 3 can also be determinable by the shape of the signal transmission path 231 located in the first attenuation reduction section M1, and the conductive property of the shielding layer (or grounding layer) 252 located in the first attenuation reduction section M1 and the distance and the structure of the electrically conductive layer 23.

A plurality of connection spots 4 are disposed on the conductive connection end 22 of the connection circuit board 2, arranged in the form of a single row or a multiple row array to electrically connect with the signal transmission path 231 of the electrically conductive layer 23 and correspond to the connection end 12 of the connection base 1. The connection spots 4 can each be one of a conductive bump, solder ball, or contact pad made by surface mounting, hot-pressing adhesion, or soldering.

To control the signal attenuation reduction function of the plurality of connection spots 4, a second attenuation reduction section M2 is provided adjacent to the conductive connection end 22 of the connection circuit board 2. In a preferred embodiment, the thickness of the insulation layer 241 located in the second attenuation reduction section M2 is increased to form a thickened insulation layer 241a, so that the thickness d1a of the thickened insulation layer 241a located in the second attenuation reduction section M2 is made larger than the thickness d1 of the insulation layer 241 in other regions. As such, the signal attenuation reduction function of the connection spots 4 can be controlled by means of the thickness and the material constant of the insulation layer located in the second attenuation reduction section M2.

Further, the signal attenuation reduction function of the connection spots 4 can also be determinable by the shape of the signal transmission path 231 located in the second attenuation reduction section M2, and the distance between the shielding layer (or grounding layer) 251 located in the second attenuation reduction section M2 and the electrically conductive layer 23.

The connection circuit board 2 can be a single-sided printed circuit board or a multi-layered printed circuit board, and the material thereof can be a flexible circuit board, a rigid circuit board, or a combined stack of the flexible circuit board and the rigid circuit board. For example, FIG. 5 shows an example of application of the present invention to a multiple-layer wiring board. Components of the instant embodiment are generally similar to those of the first embodiment, and thus, identical elements are designated with similar references for consistency. In the instant embodiment, the connection circuit board 2 comprises two or more than two electrically conductive layers 23, 23a and two or more than two insulation layers 242, 242a. Further, the structure of the multiple-layer wiring board may comprise a conductive via 27 connecting signal transmission paths 231, 231a of different electrically conductive layers 23, 23a at upper and lower sides.

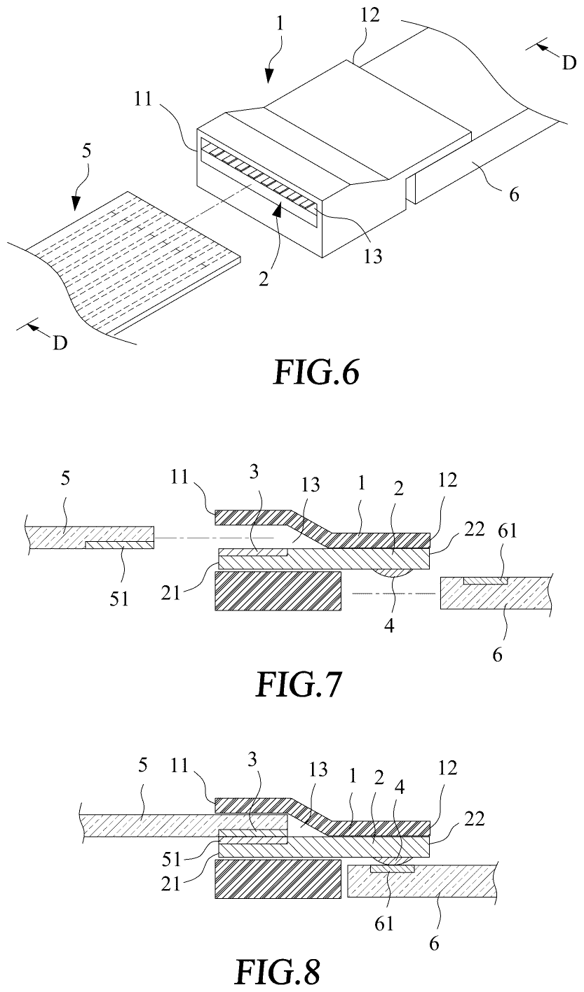

FIG. 6 is an exploded view showing the first embodiment of the present invention connecting an externally inserted flexible circuit board 5 with a circuit component 6. FIG. 7 is a cross-sectional view showing, in an exploded form, the first embodiment of the present invention connecting the externally inserted flexible circuit board 5 with the circuit component 6. FIG. 8 is a cross-sectional view showing the first embodiment of the present invention connecting the externally inserted flexible circuit board 5 with the circuit component 6. The circuit component 6 can be a flexible circuit board, a rigid circuit board, or a combination of the flexible circuit board and the rigid circuit board.

The externally inserted flexible circuit board 5 is inserted into the socket end 11 of the connection base 1, such that a conductive zone 51 of the externally inserted flexible circuit board 5 is brought into contact with the golden fingers 3 of the connection circuit board 2, and a conductive point 61 of the circuit component 6 is set in contact with the connection spots 4 of the connection circuit board 2. By means of the arrangement provided in the present invention, a high frequency signal, when transmitting among the externally inserted flexible circuit board 5, the connection circuit board 2, and the circuit component 6, is subjected to an excellent effect of impedance control and attenuation reduction to thereby ensure the quality and stability of transmission of the high frequency signal.

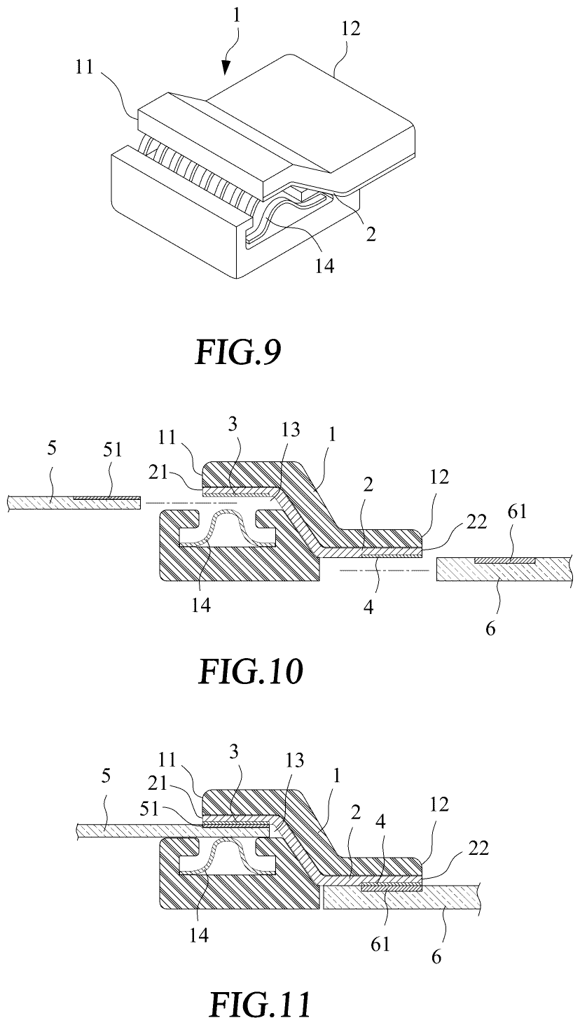

FIG. 9 is a perspective view of a second embodiment of the present invention. FIG. 10 is a cross-sectional view, showing, in an exploded form, the second embodiment of the present invention connecting a flexible circuit board with a circuit component. FIG. 11 is a cross-sectional view showing the second embodiment of the present invention connecting the flexible circuit board with the circuit component. Components of the instant embodiment are generally similar to those of the first embodiment, and but, in the instant embodiment, a push member 14 is additionally arranged in the interior space of the connection base 1 to correspond to the socket end 11, in order to provide, when an externally inserted flexible circuit board 5 is inserted into the socket end 11, a spring pushing force acting on the externally inserted flexible circuit board 5 to enhance the effect of contacting and electrically conducting between a conductive zone 51 of the externally inserted flexible circuit board 5 and the golden fingers 3 of the connection circuit board 2. Further, the channel 13 between the socket end 11 and the connection end 12 of the connection base 1 is arranged in a structural form of a curved e channel to suit the needs for different applications.

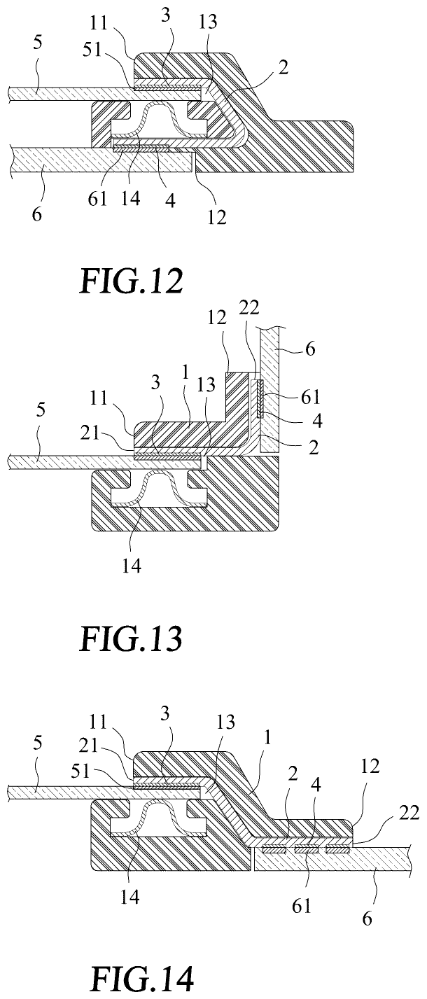

The structural arrangement of the connection base 1 can be made, for suiting requirements of various disposition, to set orientations of the socket end and the connection end as parallel directions, perpendicular directions, or directions of a preset angles relative to each other. For example, FIG. 12 is a cross-sectional view showing a third embodiment of the present invention connecting a flexible circuit board with a circuit component, and in the instant embodiment, orientations of the socket end 11 and the connection end 12 of the connection base 1 are directions that are parallel to each other and are set in the same direction. FIG. 13 is a cross-sectional view showing a fourth embodiment of the present invention connecting a flexible circuit board with a circuit component, and in the instant embodiment, orientations of the socket end 11 and the connection end 12 of the connection base 1 are directions perpendicular to each other. FIG. 14 is a cross-sectional view showing a fifth embodiment of the present invention connecting a flexible circuit board with a circuit component, and in the instant embodiment, orientations of the socket end 11 and the connection end 12 of the connection base 1 are directions that are parallel to each other and are set in opposite directions.

The embodiments provided above are illustrative structural arrangements provided for describing the present invention and are not intended to limit the present invention. Those skilled in the art may contemplate modifications and variations of the above-described embodiments within the structural arrangements and spirit of the present invention, and such variations are considered falling in the spirit of the present invention and the claims defined in the following. Thus, the scope of protection of the present invention is solely defined by the appended claims.

What is claimed is:

1. A high frequency signal connector with impedance control and attenuation reduction for a flexible circuit board, comprising:
a connection base provided with at least one socket end and at least one connection end; and
a connection circuit board at least partly received in an interior space of the connection base, having at least one contact end corresponding to the at least one socket end so that when an externally inserted flexible circuit board is inserted into the at least one socket end of the connection base, at least one conductive zone of the externally inserted flexible circuit board contacts the connection circuit board;
the connection circuit board comprising:
at least one electrically conductive layer including at least one signal transmission path;
at least one insulation layer arranged to cover a top surface and/or a bottom surface of the at least one electrically conductive layer; and
at least one shielding layer or grounding layer arranged on a top surface and/or a bottom surface of the at least one insulation layer and separated by the at least one insulation layer to correspond to the at least one electrically conductive layer;
wherein a high frequency signal is transmittable through the at least one signal transmission path, the characteristic impedance and attenuation reduction characteristic of the high frequency signal are determinable according to one value or more than two values of the following:
(a) line width, line thickness, conductive material, conductive property of the at least one signal transmission path and line pitch between two adjacent signal transmission paths;
(b) thickness and material characteristic constant of the at least one insulation layer; and
(c) distance between the at least one signal transmission path and the at least one shielding layer or grounding layer, and conductivity of the at least one shielding layer or grounding layer.

2. The high frequency signal connector according to claim 1, wherein the connection base is made of a material selected from one of plastic and metals or a combination of the two, and the connection circuit board and the connection base are fixed by adhering with adhesive layers, mechanical fastening, injection molding, or a combination of at least two of them.

3. The high frequency signal connector according to claim 1, wherein the at least one insulation layer is selectively a portion of a substrate, a covering film, and pure resin, or a combination of at least two of them, and comprises a material selected from one of PI, LCP, fluorine-series materials, COP, PP, glass fibers, PET, epoxy, acrylic resins, or coating materials.

4. The high frequency signal connector according to claim 1, wherein the connection circuit board further comprises at least one grounding conductive line, and the at least one grounding conductive line is electrically connected with the at least one shielding layer or grounding layer.

5. The high frequency signal connector according to claim 1, wherein the connection base comprises at least a part of material that comprises metal, and the metal is electrically connection with the at least one shielding layer or grounding layer of the connection circuit board.

6. The high frequency signal connector according to claim 1, wherein the connection circuit board further comprises at least one power source conductive line.

7. The high frequency signal connector according to claim 1, wherein the high frequency signal is a differential mode signal, a common mode signal, or coexistence of both.

8. The high frequency signal connector according to claim 1, wherein the connection circuit board comprises at least one contact end that comprises:
a plurality of golden fingers arranged in the form of a single row or a multiple row array to electrically connect with the at least one signal transmission path and corresponding to the at least one socket end;
the plurality of golden fingers comprise a first attenuation reduction section to control a signal attenuation reduction function of the plurality of golden fingers.

9. The high frequency signal connector according to claim 8, wherein the attenuation reduction function of the plurality of golden fingers is determined by a shape of the at least one signal transmission path located in the first attenuation reduction section, a thickness and a material constant of the at least one insulation layer located in the first attenuation reduction section, a conductive property of the at least one shielding layer or grounding layer located in the first attenuation reduction section, and a distance and a structure of the at least one electrically conductive layer.

10. The high frequency signal connector according to claim 8, further comprising:
a push member disposed in the interior space of the connection base and corresponds to the connection circuit board, so that when the externally inserted flexible circuit board is inserted into the at least one socket end of the connection circuit board, a plurality of conductive zones of the externally inserted flexible circuit board are pushed to contact with the plurality of golden fingers of the connection circuit board.

11. The high frequency signal connector according to claim 1, wherein the connection circuit board further comprises a conductive connection end, and the conductive connection end comprises:
at least one connection spot arranged in the form of a single row or a multiple row array to electrically connect with the at least one signal transmission path and corresponding to the connection end, and the at least one connection spot is one of a conductive bump, solder ball, or contact pad made by surface mounting, hot-pressing adhesion, or soldering, for connection with at least one conductive point of a circuit component.

12. The high frequency signal connector according to claim 1, wherein the interior space of the connection base forms a channel communicating between the at least one socket end and the connection end, the connection circuit board extending through the channel between the at least one socket end and the connection end.

13. The high frequency signal connector according to claim 12, wherein orientations of the at least one socket end of the connection base and the connection end are parallel directions, perpendicular directions, or directions having an angle therebetween.

14. The high frequency signal connector according to claim 1, wherein the connection circuit board comprises a single-sided printed circuit board or a multi-layered printed circuit board, and comprises a material that is a flexible circuit board, a rigid circuit board, or a combined stack of the flexible circuit board and the rigid circuit board.
